(19) United States
(12) Patent Application Publication
(10) Pub. No.: US 2026/0065789 A1
(43) Pub. Date: Mar. 5, 2026

(54) PILOT ACKNOWLEDGEMENT OF TAXI CLEARANCE ON AIRPORT MOVING MAP FORMAT

(71) Applicant: Rockwell Collins, Inc., Cedar Rapids, IA (US)

(72) Inventors: Rakshith Varadaraju, Marion, IA (US); Ryan Steinbron, Iowa City, IA (US)

(21) Appl. No.: 18/816,750

(22) Filed: Aug. 27, 2024

(51) Int. Cl. G08G 5/06

(52) U.S. Cl. CPC G08G 5/51

(57) ABSTRACT

A system for displaying a taxi clearance including a display is configured to display the position of an aircraft during airport taxiing with a first sensor for detecting the location of the aircraft during airport taxiing. The display indicates the position of hold stops and taxi paths at the airport. An input provides taxi instructions into the system. The input may be manually by the pilot or via a transmission from the air traffic control. The taxi instructions are represented on the display as a taxi path on the taxiways with a first hold stop identified on the route. The display indicates the aircraft's proximity to said hold stop.

### BACKGROUND

Routing planes on a taxi system using an airport moving map involves a combination of technology, real-time data, and communication between pilots, air traffic control (ATC), and ground operations. An airport moving map system provides pilots with a digital representation of the airport layout, including taxiways, runways, gates, terminals, and other relevant infrastructure. This map is typically displayed on the aircraft's cockpit display systems (CDS) or electronic flight bags (EFBs). The map displays current aircraft position using GPS or other navigation systems. It updates in real time to reflect the aircraft's movement.

An EFB is a device (such as an iPad) that hosts applications that allow flight crews to perform a variety of functions that were traditionally accomplished by using paper products and tools. In its simplest form, an EFB can perform basic flight planning calculations and display a variety of digital documentation, including navigational charts, operations manuals, and aircraft checklists. These advanced systems are also able to display an aircraft's position on navigational charts, depict real-time weather, and perform many complex flight-planning tasks. EFBs however currently do not have a direct link to the aircraft flight controls and therefore do not have access to the aircraft's sensors.

Upon receiving taxi instructions from ATC, pilots refer to the moving map system to visualize their route from the gate to the designated runway. These instructions may be provided either verbally by the ATC or through a controller pilot datalink communication system (CPDLC). The pilot then either inputs the route or the route is loaded automatically. For example, if the pilot is utilizing an EFB, the pilot would enter the route manually. Algorithms ensure efficient routing to minimize taxiing time and fuel consumption. Pilots interact with the map to select the assigned route or make adjustments based on operational requirements.

Once a route is selected, the moving map system provides turn-by-turn guidance, akin to a GPS navigation system in a car. It highlights the taxiways and intersections to follow, ensuring pilots adhere to the designated taxi path. The system may alert pilots to upcoming route changes, intersections, hold points, or other aircraft or ground vehicle movements that may affect their path. This enhances situational awareness and helps prevent runway incursions or other safety hazards.

Optimized routing would minimize taxiing delays, reducing overall airport congestion and improving departure and arrival punctuality. It would also contribute to cost savings through reduced fuel consumption and engine wear. Most importantly, improved routing and awareness will increase the overall safety of the passengers, aircraft, and ground personnel.

### SUMMARY

The proposed invention is to implement features in the Airport Moving Map Format (AMMF) for the pilot to mark how far into the taxi route the airplane has been cleared. The airport moving map database contains the various hold spots at an airport, and these are often represented as yellow lines on the taxi route. The proposed taxi route can be represented in a second color, and the point until which the ATC clearance has been received can be represented in a first color. When the pilot receives additional clearance, the second color will change to the first color showing how far the airplane can continue taxiing. This clearance may come from the ATC or by the pilot selecting the next hold stop on the approved taxi path. For example, the ATC may instruct the pilot to proceed to a first hold stop until a second aircraft takes off from a runway the pilot needs to cross. Once the second aircraft takes off, the pilot may select the next hold stop or the ATC may clear the aircraft to the next hold stop.

The proposed innovation addresses the need for better situational awareness and effective communication in high traffic airports where both the pilots and air traffic controllers are very busy. In one embodiment the AMMF is provided with locations of the ground vehicles and hold stops via sensors on the aircraft. For example, RFid tags could be embedded in the hold stops and placed on the ground vehicles. This additional data will allow for the pilot to route the aircraft more efficiently, but may allow the pilot to plot routes on the apron of the airport.

In another embodiment, the aircraft or ATC may be provided with aircraft dimensions of other aircraft proceeding on the taxiways and runways. By understanding the dimensions of the aircraft and the actual locations of the wing tips, nose and tail, possible safety issues may be identified. The system may provide a virtual hold stop to address these safety concerns. For example, an aircraft may be held back an additional distance to allow another aircraft with a longer wingspan to pass.

### BRIEF DESCRIPTION OF THE DRAWINGS

FIG. 1 illustrates a display that may be presented by an airport moving map.

FIG. 2 illustrates an aircraft that may be represented on an airport moving map.

FIG. 3 illustrates a first embodiment of the invention.

FIG. 4 illustrates a second embodiment of the invention.

FIG. 5 illustrates a more detailed illustration of an embodiment of the invention.

FIG. 6 illustrates another embodiment of the invention.

### DETAILED DESCRIPTION

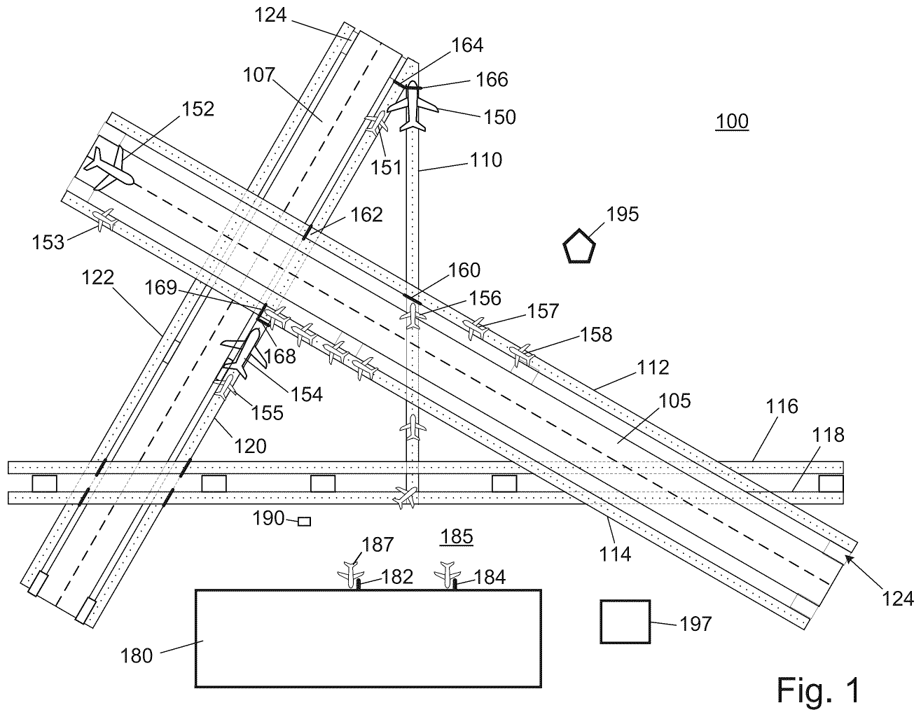

FIG. 1 illustrates a display 100 that may be configured to be provided by an airport moving map. The display 100 may be presented by the cockpit display or by an EFB. The display will illustrate the organization of the airport and where the aircraft is currently located. The display may illustrate a first runway 105 and a second runway 107. The display may further indicate various taxiways 110, 112, 114, 116, 118, 120 & 122. In addition, the taxiways may have run up areas 124, which allow the aircraft to move from one taxiway to the runways. The airport moving map may further display the terminal 180 and gates 182 and 184. In addition, the airport moving map may display aircraft 150 and ground vehicles 190. In addition, it is possible that the airport moving map may display the hold short locations 160, 162, 164, 166, 168, 169 on the taxiways and/or runways. In addition, a ground station GPS transmitter 195 may be provided for GPS greatly enhancing the accuracy of an aircraft's GPS sensor which detects the location of the aircraft when at the airport. Further, the airport may have an apron 185 that allows the aircraft to travel from the terminal 180, hangars (not shown), and other services such as a deicing station 197. All of these areas may be illustrated in some form on the airport moving map.

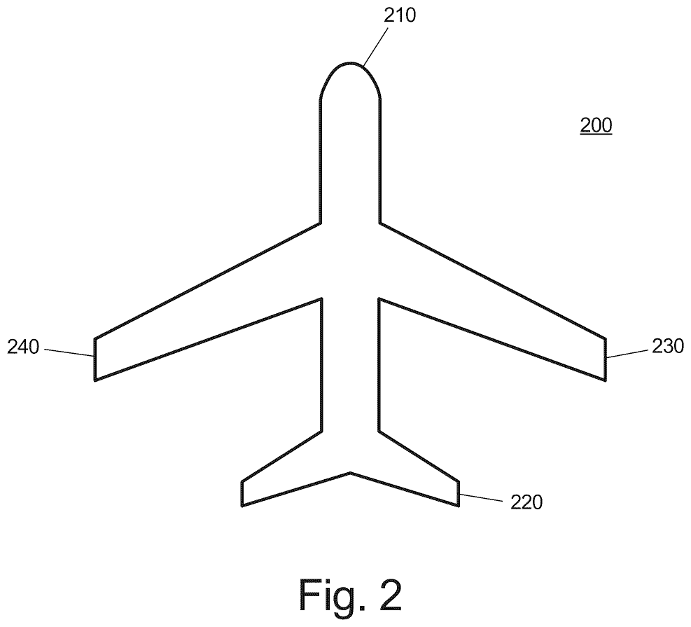

FIG. 2 illustrates a top down view of an aircraft 200. The aircraft 200 is a simplified view to illustrate the dimensional information about the aircraft. As can be seen, the aircraft 200 has a nose 210 and a tail 220. The length of the aircraft is measured from the nose 210 to the tail 220. The second measurement is from the right wingtip 230 to the left wingtip 240. The dimensions of an aircraft may vary dependent upon which aircraft is selected. For example, an Airbus A380-800 has a length of 72.73 meters (239 feet) and a wingspan of 79.80 meters (262 feet). Conversely, a Citation V has a length of 14 meters (49 feet) and a wingspan of 16 meters (52 feet). While these two aircraft are exemplary of aircraft found at many airports, it is clear that the aircraft have significantly different dimensions. Airport moving maps often display the aircraft with a generic symbol that does not indicate the actual size of the aircraft and is only centered upon the transmitted location, possibly by an ADS-B or GPS transmitter.

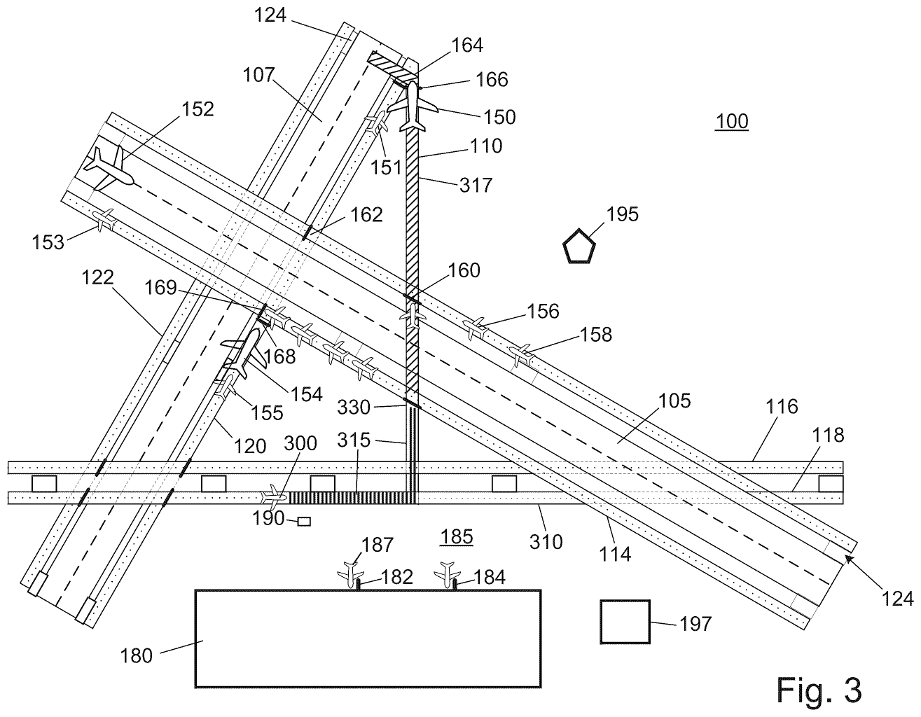

FIG. 3 illustrates a first embodiment of the invention. Where appropriate, FIG. 3 shares the same identifications as FIG. 1. In one embodiment, an aircraft 300 may be routed to take off from runway 107. It is noted that aircraft 300 is initially located on taxiway 118. Aircraft 300 would have moved from a gate at terminal 180 across apron 185. The aircraft 300 may be routed by air traffic control via taxiway 118 and taxiway 110 to runway 107. As can be seen, to proceed to runway 107, aircraft 300 will need to cross runway 105. The system may provide data to aircraft 300 to indicate if runway 105 is active or inactive. As aircraft 152 is currently in position to takeoff down runway 105, the ATC has requested aircraft 300 to stop at hold stop 330. To ensure the pilot is aware of the taxi path proposed by the ATC, the first part of the route 315 may be indicated in a first color, such as cyan or green and shading. As indicated in addition to colors, the route may be indicated by shading, such as stripes, diagonal, or checkered lines. The hold stop 330, may be identified on the display as an indicator color such as yellow so it is clearly identified. The hash marks are commonly marked on the runways and taxiways as yellow stripes to indicate to the pilots where to stop. The second part of the taxi path 317 proposed by the ATC past the hold stop 330 may be a second color such as green or white. In addition, an active runway 105 may be indicated by a warning color such as red to ensure the pilot is aware of the safety issue.

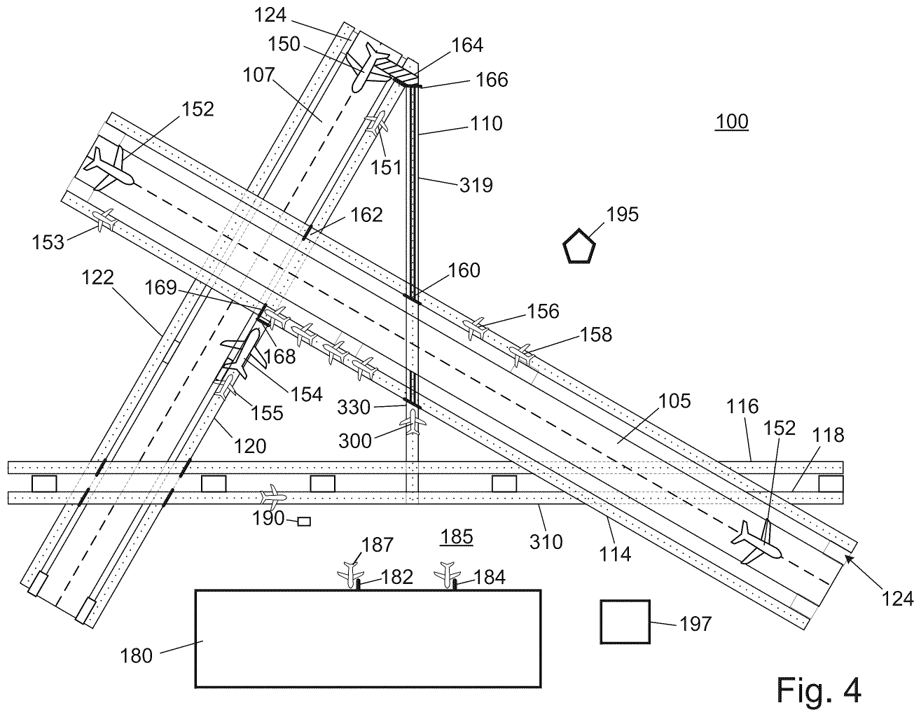

As shown in FIG. 4, once aircraft 152 takes off, and clears the runway 105, the ATC may provide a taxi clearance and clear the aircraft 300 to hold stop 166. As shown in FIG. 4, runway 105 is now clear, and therefore the aircraft 300 may pass hold stop 330 and proceed to hold stop 166 safely. As seen in FIG. 4, the clear portion of the taxi route 319 is now the first color and shading. This indicates to the pilot of aircraft 300 that it is safe to cross runway 105 and proceed along the taxiway. The improved methodology taught in FIG. 3 and FIG. 4 illustrates a method and apparatus to allow the ATC to indicate to the pilot the route to the final destination, runway 107, and indicates how far the aircraft may safely proceed.

There are a number of additional issues that may be addressed in additional embodiments. FIG. 1 illustrates a number of aircraft on the taxiways and runways. For example, aircraft 154 on taxiway 120 may be stopped at hold short 168. Aircraft 154 is a larger aircraft such as an Airbus A380-800. One embodiment of the invention may include indicating the size and orientation of the aircraft on the airport moving map, thereby adding to the information available to the pilot, increasing safety. As can be seen, the wing of aircraft 154 may intrude over runway 107 creating a safety hazard. Unless the display 100 indicates the size and orientation of aircraft on the taxiway or runway, the pilot and ATC may not be aware of the potential safety hazard. In addition, aircraft 155 may be a smaller aircraft such as a Citation or other smaller jet. As can be seen, the wingspan of aircraft 155 does not impinge upon runway 107, thus not creating the safety issue presented by the larger aircraft 154. As can be seen in FIG. 4, aircraft 150 is preparing to take off on runway 107 while aircraft 154 may be stopped at hold stop 168. As can be seen, by illustrating the size of the aircraft, it is clear if aircraft 150 and 154 are larger than the airport was normally designed to handle, there may be an issue due to the wingspan of the aircraft. For example, if both aircraft are Airbus A380s, it is possible that the wingtip of aircraft 154 may intrude into runway 107. As aircraft 150 also has a wide wingspan, it is possible that the wingtips of the two aircraft 150 and 154 would make contact. One embodiment of the invention may be to indicate the size of the aircraft on the display. By knowing the size of the aircraft, as shown in FIG. 4, runway 107 may be highlighted as red and/or have shading to indicate runway 107 is not safe because of the potential contact between the wingtips of the two aircraft 150 and 154.

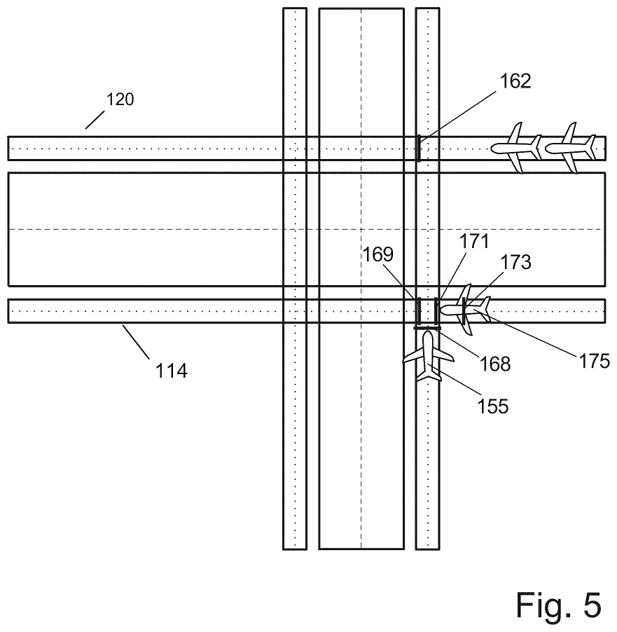

Further, as can be seen in FIG. 1, aircraft 156 may be held at hold stop 160 blocking runway 105 for aircraft 152. There is a need in the industry to not only route aircraft during the taxi process, but to ensure they are safe while moving or stationary on the runway or taxiway. Hold stops may be painted on the taxiways and runways to indicate to the pilot where to stop. The location is further available from the airport moving map and if a ground based GPS 190 is present at the airport, the pilot will know exactly where they are relative to the hold stop. As can be seen in FIG. 5, the location of hold stops may not prevent contact. For example, if aircraft 175 is stopped at hold stop 171, aircraft 155 will not be able to pass aircraft 175 without contact. In one embodiment, hold stop 171 may be adjusted to allow for aircraft 155 to pass safely. Hold stop 173 would be indicated virtually on the display 100 rather than being fixed on the taxiway 114. As shown, hold stop 171 may adjust backward to hold stop 173 when aircraft 155 is routed by the ATC down taxiway 120. The variable hold stop 173 may be adjusted by the ATC or automatically by a system tracking the aircraft in the airport.

In another embodiment, indicators may be installed in hold stop locations such as hold stop 168 shown in FIG. 5. Indicators may provide a signal to the aircraft such as aircraft 155 of the location of hold stop 168. For example, an RFid tag may be embedded in hold stop 168, such that as aircraft 155 approaches hold stop 168, the pilot has greater awareness of the hold stop 168 location. This may be accomplished by having a proximity detector in the aircraft to detect the RFid tag. In addition, RFid tags may be added to ground vehicles 190 to ensure that the pilots are aware of ground vehicle 190 locations dynamically.

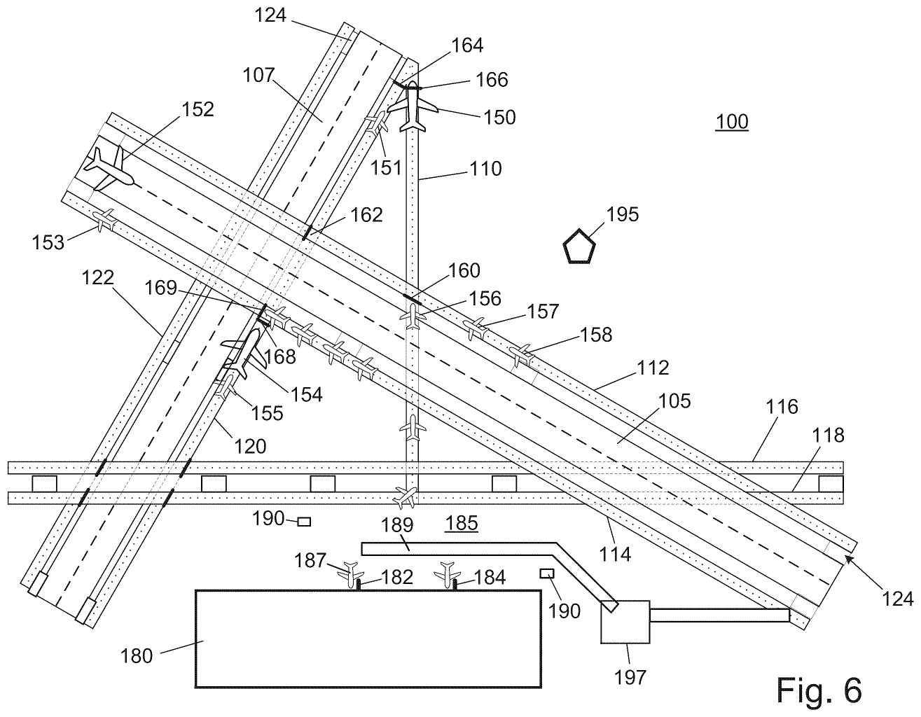

In another embodiment aircraft 187 may wish to leave gate 182 and move to deicing station 197. As seen in FIG. 1, the route to deicing station 197 would be across apron 185. Current means for routing aircraft 187 would require the aircraft 187 to be guided by ground personnel or to “drive” to the deicing station 197, using only the information the pilot can see through the windshield. As shown in FIG. 6, aircraft 187 may be provided with a route 189 to deicing station 197. As seen, by providing location information of other aircraft and ground vehicles 190, it is possible to create route 189 for aircraft 187 to deicing station 197 and later to taxiway 114 safely. By adding RFid tags or other means to detect ground vehicles 190, it is possible that the display 100 may dynamically reroute aircraft 187 to provide a safe route to deicing station 197.

As shown in FIG. 6 the route may be provided to the aircraft by the ATC or the aircraft may calculate the taxi path to the deicing station 197 by means of a computer system utilizing a micro processor. Alternatively, the taxi path to the deicing station 197 may be input by the pilots utilizing the data provided by the display to map a safe taxi path to the deicing station. In another embodiment, the selected taxi path may be shared with the ATC or ground operations. By plotting a course prior to embarking on the taxi path to deicing station 197, the pilot and passengers are provided with a safer route to the final destination.

While the detailed drawings, specific examples and particular formulations given describe preferred and exemplary embodiments, they serve the purpose of illustration only. The inventions disclosed are not limited to the specific forms shown. For example, the methods may be performed in any of a variety of sequence of steps. The hardware and software configurations shown and described may differ depending on the chosen performance characteristics and physical characteristics of the computing devices. For example, the type of computing device, communications bus, or processor used may differ. The systems and methods depicted and described are not limited to the precise details and conditions disclosed. In this application, the term real-time refers to performance of an activity in real time, pseudo real time, or actively in time for performance of an activity. Furthermore, other substitutions, modifications, changes, and omissions may be made in the design, operating conditions, and arrangement of the exemplary embodiments without departing from the scope of the invention as expressed in the appended claims.

1. A system for displaying a taxi clearance, said system comprising:
a display configured to display a position of an aircraft during airport taxiing;
a first sensor for detecting the position of the aircraft during airport taxiing;
wherein the display indicates a location of one or more hold stops;
an input to provide taxi instructions into the system, wherein the taxi instructions are represented on the display; and
wherein the display displays a taxi path and identifies a first hold stop on the route and wherein the display indicates a taxi path to the first hold stop, the taxi path to the first hold stop indicated with a first indicator, and a taxi path from the first hold stop to a final destination indicated with a second indicator.

2. The system of claim 1 wherein the first sensor is a GPS sensor.

3. The system of claim 1 wherein a second sensor in the aircraft is a proximity detector to detect a location of the one or more hold stop.

4. The system of claim 1, wherein the system obtains dimensional information of the aircraft.

5. The system of claim 4 wherein the first sensor determines a position of a nose, one or more wing tips, and a tail of the aircraft.

6. The system of claim 4, wherein a virtual hold stop is calculated based on the dimensional information of the aircraft and the virtual hold stop is displayed.

7. The system of claim 6, wherein the system obtains the dimensional information of at least one other aircraft in proximity to the aircraft.

8. The system of claim 7, wherein the virtual hold stop is based in part on the dimensional information of the at least one other aircraft.

9. The system of claim 1 wherein the input is provided by a controller pilot datalink communication system (CPDLC).

10. The system of claim 1, wherein the pilot inputs the taxi instructions.

11. The system of claim 1, wherein the display further indicates active and inactive runways.

12. They system of claim 1, wherein the display indicates the location of other aircraft.

13. The system of claim 12, wherein the display indicates the location of ground vehicles.

14. The system of claim 1, wherein the system displays the taxi path to the first hold stop in a first color and a remaining taxi path with a second color.

15. Then system of claim 1, wherein the system displays the taxi path to the first hold stop with a first shading and the taxi path for the remaining taxi path with a second shading.

16. A system for displaying a taxi path for an aircraft at an airport, said system comprising:
a display configured to display the position of the aircraft at the airport;
a first sensor for detecting the location of the aircraft on an apron of the airport;
an input to provide a destination of the aircraft to a location at the airport, wherein the destination is on the apron of the airport;
a processor for calculating a taxi path from the current location of the aircraft to the destination; and
wherein the display displays the taxi path to the destination.

17. The system of claim 16, wherein the system identifies hold stop locations, wherein the hold stop location is adjusted to provide for a virtual hold stop location.

18. The system of claim 17, wherein the virtual hold stop location is set based on aircraft dimensions of aircraft in proximity to the aircraft.
